(19) United States
(12) Patent Application Publication
(10) Pub. No.: US 2023/0083683 A1
(43) Pub. Date: Mar. 16, 2023

(54) ION BOOSTER FOR THRUST GENERATION

(71) Applicant: University of Miami, Miami, FL (US)

(72) Inventor: Tomas Antony Pribanic SOLARI, Miami, FL (US)

(21) Appl. No.: 17/790,230

(22) PCT Filed: Jan. 8, 2021
(86) PCT No.: PCT/US2021/012649

§ 371 Date: Jun. 30, 2022

Related U.S. Application Data
(60) Provisional application No. 62/959,679, filed on Jan. 10, 2020.

(51) Int. Cl. F03H 1/00; B64G 1/40; H01G 4/12

(52) U.S. Cl. CPC F03H 1/0006; B64G 1/405; H01G 4/1272

(57) ABSTRACT

Ion booster for thrust generation. The invention pertains to electrical propulsion generated by the rapid acceleration of ions between asymmetrical electrodes. The invention is applicable for propulsion generation in atmospheric and space environments.

### FIELD OF THE INVENTION (TECHNICAL FIELD)

The present invention relates to propulsion generating technologies. Specifically, to propulsion generated by electrical sources (electric propulsion) with the use of electrodes subjected to a potential (voltage) differential.

Generation of thrust from electrodes subjected to a potential differential was first discovered in 1928 by T.T. Brown. Since then, numerous inventions have emerged using this principle to generate thrust to propel vehicles. Inventions have used different electrodes arrangements and configurations to increase the thrust levels. However, the basic principle used by Brown has remained unchanged in these inventions.

Three pillars will drive the aerospace market in the next ten years: 1) autonomous flying; 2) aircraft communications; and 3) electric propulsion. Additionally, as NASA continues to investigate the feasibility of hybrid and all-electric aircraft for future commercial use, several key electric power-related components and materials need to be developed or refined to meet the ambitious power goals established by the agency’s Advanced Air Transport Technology (AATT) Project.

The U.S. Department of Defense has great interest in ion thrusters for space application. As stated on the SBIR announcement AF192-044 future DoD spacecraft will need greater agility to change orbits for mission requirements or to avoid the increasing hazards in crowded orbits. An agile spacecraft is one that can make an orbital change while maximizing propulsive life through propellant conservation. Agility requires, at minimum, propulsion concepts that are able to trade specific impulse (Isp) with thrust over a wide range as mission needs require. Short notice needs would require high thrust at the expense of propellant. Mission needs that have less severe time constraints can use high Isp and conserve propellant. However, a truly agile spacecraft will require both high thrust and high Isp simultaneously, at least for short periods of time,

Thrust using electrodes at high potential difference is achieved by using electrodes of significant different sizes having opposite voltage polarity. A smaller electrode (having higher current density) attracts existing opposite charged ions and/or electrons from the surrounding medium (i.e. air, nitrogen, xenon gas) at high speeds. On their path, these ion or electrons collide with neutral molecules. These collisions cause the neutral molecules to gain or lose an electron. The impacted molecules now polarized are attracted to the larger electrode at high speed and their acceleration generates thrust.

It’s important to note that ionic wind is generated by these high-speed traveling molecules, but it is not the main source of propulsion (they have a lower contribution by several orders of magnitude).

So far, the use of high voltage electrodes to generate thrust has only been successful in space applications. Spacecraft use Xenon gas as the medium (which has a large molecular weight) to increase the momentum generated when molecules are accelerated. Low levels of thrust are generated but since there are no friction forces in space, the thrusters are used for long intervals until the desired velocity is achieved. However, spacecrafts pay the weight penalty of carrying the Xenon gas as fuel.

### SUMMARY OF THE INVENTION

In atmospheric conditions, generation of useful thrust levels have not been achieved due to the limitation of using air as the medium. The limitations are due to the air’s dielectric breakdown voltage and the availability of ions in the atmosphere.

Embodiments of the present invention herein presented boost the thrust levels of an ion thruster by extracting electrons from the electrodes. This is achieved by overcoming the work function of the electrode material. As electrons are extracted, they generate additional collision with the surrounding medium thus increasing the number of charged molecules. The acceleration of the increased number or charged molecules and the electrons increases the thrust levels of the ion thruster.

The embodiments of the invention are applicable to any medium (i.e. Xenon gas, nitrogen, air). Notably, the use of the embodiments of the present invention in atmospheric conditions increases the thrust levels to a point which makes ion thrusters a viable option for electrically powered aircraft.

In an embodiment a system is disclosed which includes one or more primary electrodes; at least one secondary electrode; a high voltage power supply having a ground output operationally connected to said one or more primary electrodes, said high voltage power supply further having a positive output operationally connected to said at least one secondary electrode; and an energy source to overcome the work function of a material of said one or more primary electrodes when energized.

In an embodiment, the energy source can comprise a secondary power supply operationally connected in a closed circuit to said one or more primary electrodes to increase the temperature of said one or more primary electrodes when energized. Alternatively, the energy source can comprise a heating element for heating said one or more primary electrodes or a UV light source in proximity to said one or more primary electrodes. Further, combinations of the three energy sources can be used.

In various embodiments the one or more primary electrodes can comprise a ceramic material, a semi-conductor material and a conductive alloy material, or various combinations of those materials.

An embodiment comprises multiple cells arranged in a linear configuration, each cell one of the systems described above. Alternatively, multiple such cells can be arranged in a cylindrical configuration.

In an embodiment a method is disclosed for generating thrust using an ion thruster system having one or more primary electrodes, at least one secondary electrode, a high voltage power supply, and an energy source to overcome the work function of a material of said one or more primary electrodes when energized, the method comprising: supplying high voltage power to said one or more primary electrodes and said at least one secondary electrode with a ground output of said high voltage power supply supplying the high voltage power to said one or more primary electrodes and a positive output of said high voltage power supply supplying the high voltage power to said at least one secondary electrode; and applying energy from the energy source to overcome the work function of a material of said one or more primary electrodes.

In embodiments applying energy from the energy source can comprise applying electrical power to said one or more primary electrodes from a secondary power supply to heat the one or more primary electrodes, using a heating element for heating said one or more primary electrodes and applying UV radiation to said one or more primary electrodes or various combinations of the foregoing methods for applying energy from the energy source.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a simplified schematic of an embodiment of the invention;

FIG. 2 shows a simplified schematic of the principle of the embodiments of the invention;

FIG. 3 is a schematic of an embodiment of the invention using conductive metal alloy electrodes;

FIG. 4 is a schematic of embodiments of the invention using a ceramic or semi-conductive electrode;

FIG. 5 is a schematic of an embodiment of the invention using UV (ultra violet) light radiation;

FIG. 6 is an embodiment of the invention on a single linear cell configuration;

FIG. 7A is an embodiment of the invention comprising multi-cell configuration for linear thrusters;

FIG. 7B is an embodiment of the invention comprising multi-cell configuration for cylindrical thrusters;

FIG. 8 shows the experimental set up for testing an embodiment of the invention;

FIG. 9 shows in more detail the constant springs used in the set-up of FIG. 8 to help maintain the tension of the electrodes regardless of their temperature;

FIG. 10 shows the results from the experimental set up of FIG. 8 where a baseline was created using the high-power supply only and was then compared to the thrust improvement when the secondary power supply was added to heat up the small electrodes;

FIG. 11 shows the improvement as a percentage of thrust increase.

### DETAILED DESCRIPTION OF THE INVENTION

In the following detailed description, numerous specific details are set forth in order to provide a thorough understanding of the embodiments of the invention. However, upon studying this application, it will be understood by one of ordinary skill in the art that the embodiments may be practiced without these specific details. For instance, well known operation or techniques may not be shown in detail. Technical and scientific terms used in this description have the same meaning as commonly understood to one or ordinary skill in the art to which this subject matter belongs.

As used throughout this application, the term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (i.e. "top," "bottom," "FWD," “AFT, "above," “below”) are merely used to describe the orientation of various elements in the figures. It should be noted that the orientation of various elements may differ according to other exemplary embodiments, and that such variations are intended to be encompassed by the present disclosure.

Embodiments of the present invention provide a technology-based solution that can overcome existing problems with the current state of the art in a technical way to satisfy an existing problem for Private, Commercial, and Military Transportation for Atmospheric and Space travel. Known ion thruster art only optimizes the basic principle discovered and patented by T.T. Brown in 1928. Embodiments of the invention can use a new physical principle which boosts the thrust of ion thrusters to unprecedented levels by extracting electrons from the electrode[s]. Embodiments of the invention comprise ion thruster cells that may have several configurations. In the various possible configurations, ion thruster cells generally provide superior thrust levels than the state of the art by extracting electrons from the electrode[s] disclosed herein to increase the amount charged ions created by collisions between the electrons and the neutral molecules of the medium. The electrons are also accelerated. This acceleration of electrons' mass also contributes to the increase in thrust.

Embodiments of the invention can use three physical principles to generate thrust: asymmetric electrodes (different sizes) subjected to a potential differential, electrostatic forces created by potential differential, and overcoming the work function of the electrode’s material.

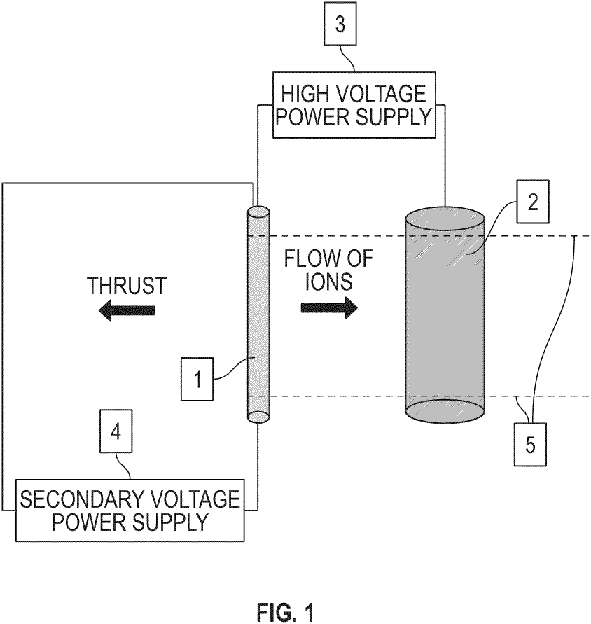

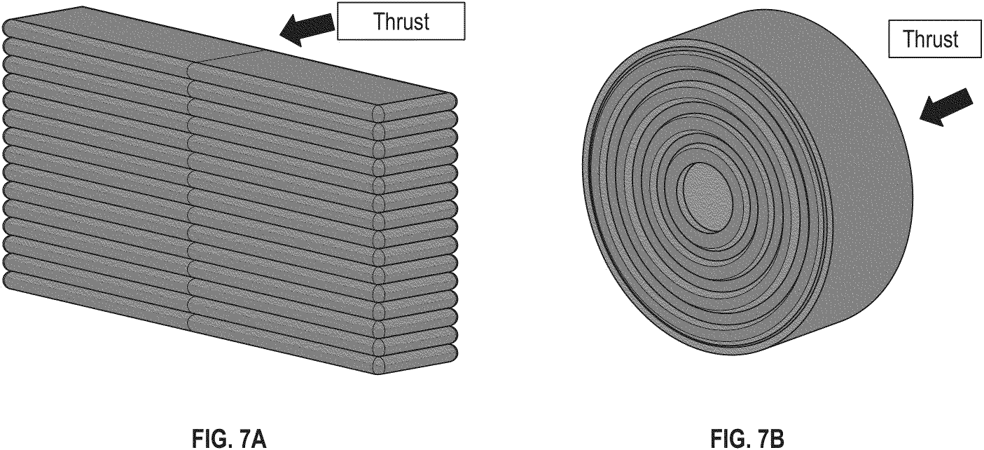

Referring now to FIGS. 1-5, schematics are shown of different aspects and various embodiments of the invention comprising three possible exemplary energy sources to overcome the work function of the material of a smaller electrode, namely: 1) heating by electricity, 2) secondary heating; and 3) radiation from an UV light source. In the various embodiments of the invention, electrons are pulled from an electrode by overcoming the work function of its material. FIGS. 7A and 7B show embodiments of the invention: linear stackable cells and cylindrical stackable cells.

Referring in more detail to FIG. 1, according to an embodiment, electrode 1 and electrode 2 are preferably made of conductive alloys. In one embodiment electrode 1 (also referred to as the primary electrode) is preferably smaller than electrode 2 (also referred to as the secondary electrode). In one embodiment, high voltage power supply 3 is connected to electrodes 1 and 2. The ground (negative) output of high voltage power supply 3 is operationally connected to electrode 1 and the positive output of high voltage power supply 3 is operationally connected to electrode 2. The operational connections can be accomplished directly (e.g., direct wiring) or indirectly (e.g., having intervening elements such as amplifiers or other circuitry). Electrode 1 and electrode 2 are preferably attached to structure 5. When electrode 2 is larger than electrode 1, thrust is generated by the asymmetric electrodes subjected to a large potential difference. Additionally, electrostatic attractive forces are created between the electrodes but are transferred to structure 5 and do not contribute to the thrust generated.

In one embodiment, electrode 1 is also connected to secondary power supply 4. The material of electrode 1 is preferably such that it increases temperature as the secondary power supply is energized. Once secondary power supply 4 is energized, the temperature of smaller electrode 1 begins to increase and starts approaching the work function temperature of its material. Additionally, the electrostatic forces created between the electrodes contribute to overcoming the work function of electrode 1. Electrons are pulled from the surface of electrode 1 by the increased temperature and the electrostatic forces.

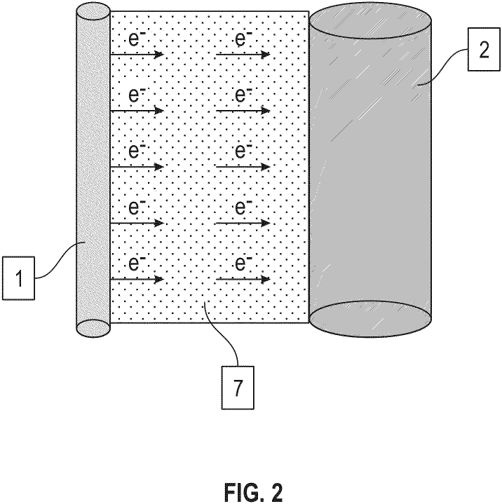

FIG. 2 shows the electrons being pulled from the surface of electrode 1, which, in one embodiment, are attracted by larger electrode 2 that has a large positive voltage potential. The electrons leaving smaller electrode 1 travel at a very high speed thru medium 7. The medium can be air, nitrogen gas, xenon gas or other types of gases. The molecules in medium 7 are impacted by the electrons leaving electrode 1 which create additional ions in medium 7. Newly created negatively charged ions are accelerated towards larger electrode 2, which significantly increases the thrust generated by the system. Electrons leaving electrode 1 may also be accelerated toward electrode 2 without colliding with neutral molecules.

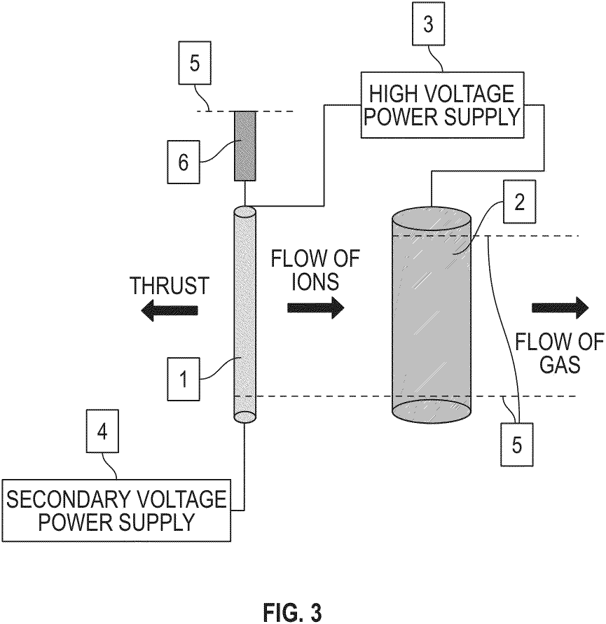

FIG. 3 shows the schematic of an embodiment with the addition of constant force element 6. As the temperature of the electrode 1 increases, it expands which increases its length. Constant force element 6 ensures that electrode 1 remains in constant tension regardless of its temperature.

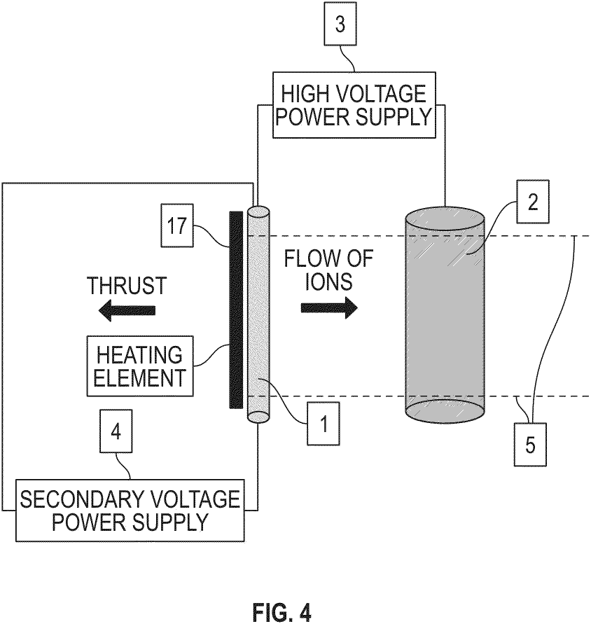

Generally, the mechanism of overcoming the work function of a material by increasing its temperature is termed Thermionic Emission. Materials used for the electrode 1 can be metal alloys, ceramics, and semi-conductors. In the case of ceramics and semiconductors, it is necessary to heat up the material for it to become conductive of electricity. In one embodiment, this is accomplished by introducing heating element 17 shown in FIG. 4. Once the material has been heated up using heating element 17 it becomes conductive and secondary power supply 4 can be energized and the system will operate as previously described. At this point, heating element 17 can be removed. Materials requiring heating prior to becoming conductive include, but are not limited to, Yttrium, Zinc dioxide, and other materials capable of releasing higher quantities of electrons to the medium.

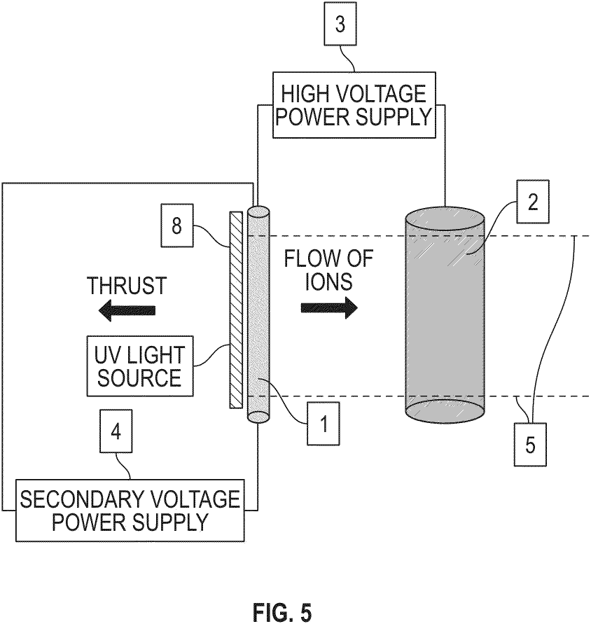

In another embodiment, the work function of a material is overcome by UV light radiation. FIG. 5 shows a schematic of an embodiment of the invention using UV light source 8 to radiate electrode 1 to contribute in overcoming its material work function.

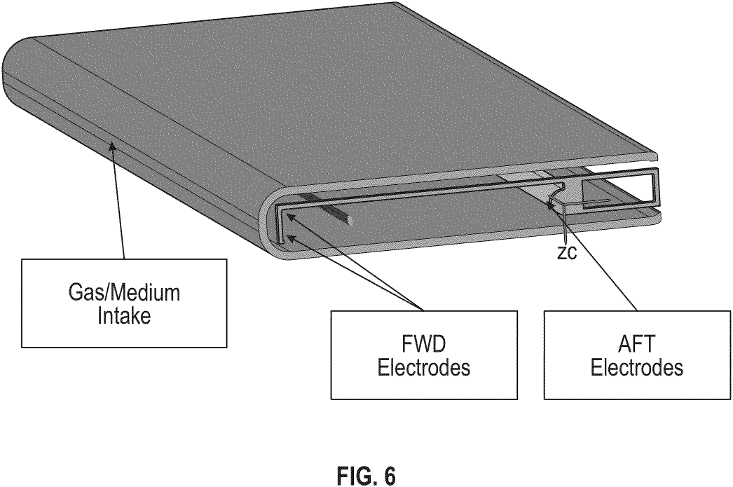

FIG. 6 shows an embodiment in a single cell configuration. Inside the cell, the electrodes are fixed to a structure and the medium is provided at the intake of the cell. Any of the earlier described arrangements can be implemented in the shown configuration.

FIG. 7A shows an embodiment in a multi-cell linear configuration and FIG. 7B in a cylindrical configuration. They can be stacked or placed concentric to each other. Any of the earlier described arrangements can be implemented in the shown configurations.

In addition to the embodiments presented, the thruster’s configuration can include a plurality of electrode arrangements to optimize the thrust generated. Embodiments of thrusters can also be multistage where a second, third or more thrusters are placed in an array one behind the previous.

The various embodiments of the present invention can significantly increase the thrust levels in an ion thruster by extracting electrons of an electrode. The increased levels of thrust enable the use of the ion propulsion technology in atmospheric conditions and increases the performance of ion thrusters for space travel. Embodiments of the invention provide a major break-thru in the field of atmospheric electric propulsion making the use of the ion thrusters technologies a feasible option for generating thrust. For space travel, the embodiments of invention provide higher thrust level which enable spacecraft to perform agile quick response maneuvers and increases the velocity of spacecrafts shortening mission times.

### Industrial Applicability

The invention is further illustrated by the following non-limiting examples.

### Example 1

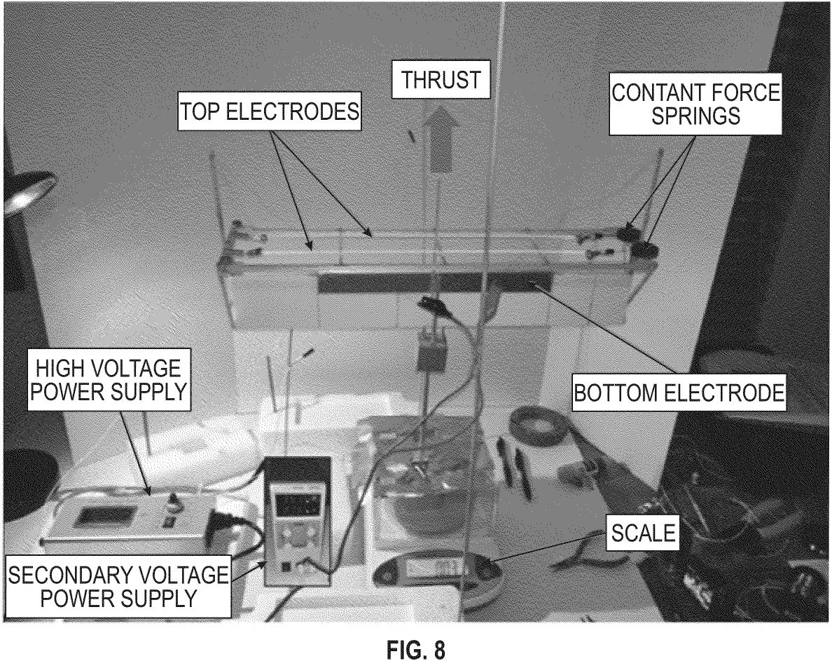

An embodiment was implemented using the experimental set-up shown in FIG. 8. The experimental set-up comprised two top electrodes and one bottom electrode. The top electrodes had diameters of 0.0005 inches, and they were made out of Nichrome 80 material. The bottom electrode had a diameter of 0.1875 inches, and it was made from cardboard foam and wood covered in aluminum foil. All electrodes were made from conductive material. All electrodes had a length of 12 inches.

The high power supply had a maximum delivery voltage of 30.7 KV DC at 0.5 milli-Amps. The high voltage power supply was used to its maximum rated capacity. The secondary voltage power supply had a maximum delivery voltage delivery of 60 V DC at 5 Amps. The secondary power supply was used to a voltage of 32 V DC.

The electrodes were fixed to a wood structure which was mounted on a scale. The scale recorded the amount of upward thrust achieved by the system for given voltages (mass multiplied by gravity).

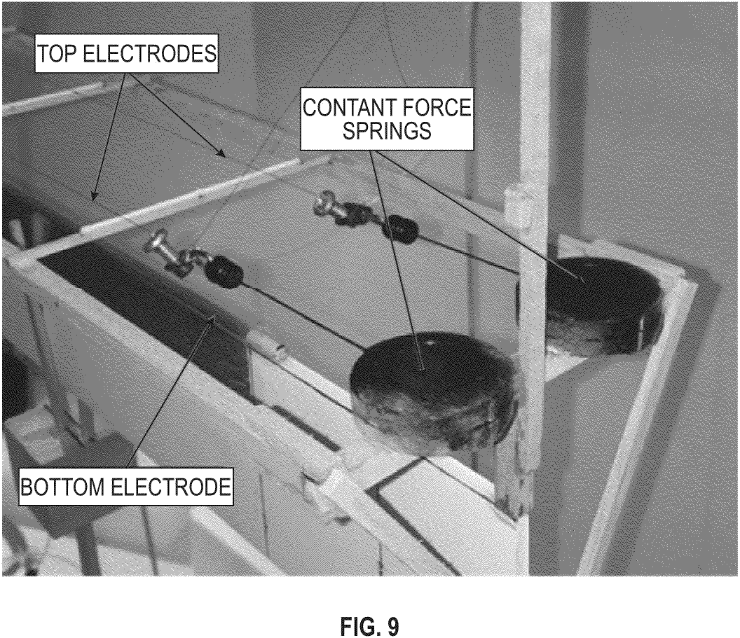

The top electrodes were fixed at one end of the structure and were mounted onto constant springs at the other end to ensure their tension remain constant regardless of the thermal expansion of the top electrodes when their temperature increased (See FIG. 9).

The top electrodes were connected to the ground (negative) of the high voltage power supply. The bottom electrode was connected to the positive output of the high voltage power supply.

The top electrodes were also connected in parallel to the secondary power supply at each end. This created a close circuit with the secondary power supply.

The experiment was first conducted by only energizing the high voltage power supply and thrust measurements were recorded by varying the output of the high voltage power supply from 10 KV to 30.7 KV.

The experiment was then repeated but with both power supplies (high voltage power supply and secondary voltage power supply) energized. Measurements of thrust were recorded by varying the output of the high voltage power supply from 10 KV to 30. The secondary power supplied set to 32 V DC and remained unchanged.

The difference of the measurements between the first and second experiment demonstrate the improvement that embodiments of the invention can provide to the level of thrust generated.

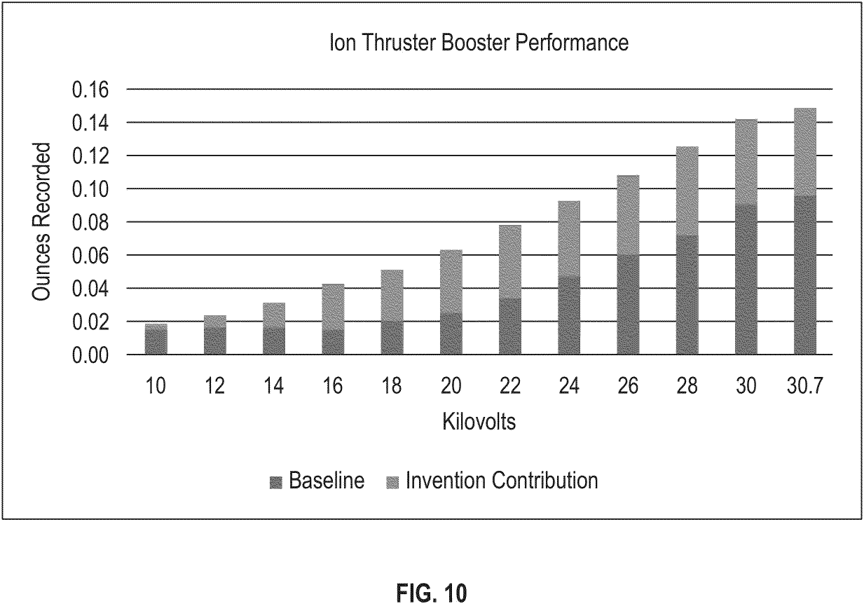

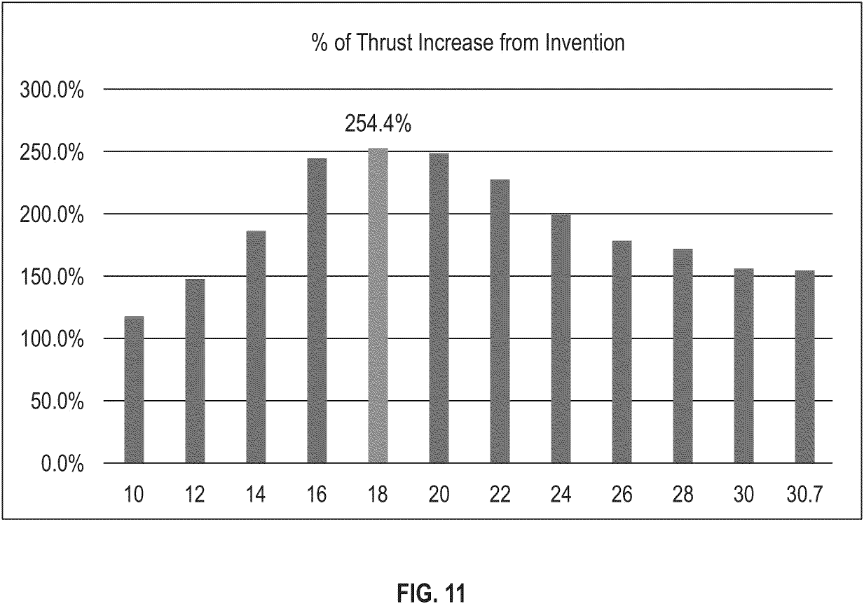

FIG. 10 shows the experimental results showing the contribution of the improvement in the increased of thrust levels. FIG. 11 shows the percentage of improvement in the thrust achieved. Surprisingly, results showed an unexpected maximum contribution of 254.4% for 18KV input voltage from the high voltage power supply.

The preceding example was for a single cell thruster. The example can be repeated using a plurality of electrodes configuration and a plurality of voltage polarities supplied to the electrodes.

The preceding example can be repeated with similar success by substituting the electrode materials with ones having lower work function which may require heating the top electrodes prior to energizing the secondary voltage power supply. The example can also be repeated with materials which work function can be reached by UV light irradiation.

Although the invention has been described in detail with particular reference to these described embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. An ion thruster system comprising:
one or more primary electrodes;
at least one secondary electrode;
a high voltage power supply having a ground output operationally connected to said one or more primary electrodes, said high voltage power supply further having a positive output operationally connected to said at least one secondary electrode; and
an energy source to overcome the work function of a material of said one or more primary electrodes when energized.

2. The ion thruster system of claim 1 wherein said energy source comprises a secondary power supply operationally connected in a closed circuit to said one or more primary electrodes to increase the temperature of said one or more primary electrodes when energized.

3. The ion thruster system of claim 2 wherein said one or more primary electrodes comprise a conductive alloy material.

4. The ion thruster system of claim 1 wherein said energy source comprises a heating element for heating said one or more primary electrodes.

5. The ion thruster system of claim 4 wherein said one or more primary electrodes comprise a ceramic material.

6. The ion thruster system of claim 4 wherein said one or more primary electrodes comprise a semi-conductor material.

7. The ion thruster system of claim 1 wherein said energy source comprises a UV light source in proximity to said one or more primary electrodes.

8. The ion thruster system of claim 7 wherein said one or more primary electrodes comprise a ceramic material.

9. The ion thruster system of claim 7 wherein said one or more primary electrodes comprise a semi-conductor material.

10. The ion thruster system of claim 1 further comprising a constant force element operationally connected to said one or more primary electrodes to maintain a constant tension on said one or more primary electrodes regardless of their temperature.

11. A multi-cell ion thruster system comprising multiple cells arranged in a linear configuration, each cell comprising an ion thruster according claim 1.

12. A multi-cell ion thruster system comprising multiple cells arranged in a cylindrical configuration, each cell comprising an ion thruster according claim 1.

13. The ion thruster system of claim 10 wherein said constant force element is constant force tension springs.

14. A method of generating thrust using an ion thruster system having one or more primary electrodes, at least one secondary electrode, a high voltage power supply, and an energy source to overcome the work function of a material of said one or more primary electrodes when energized, the method comprising:
supplying high voltage power to said one or more primary electrodes and said at least one secondary electrode with
a ground output of said high voltage power supply supplying the high voltage power to said one or more primary electrodes and
a positive output of said high voltage power supply supplying the high voltage power to said at least one secondary electrode; and
applying energy from the energy source to overcome the work function of a material of said one or more primary electrodes.

15. The method of claim 14 wherein applying energy from the energy source comprises applying electrical power to said one or more primary electrodes from a secondary power supply to heat the one or more primary electrodes.

16. The method of claim 14 wherein applying energy from the energy source comprises using a heating element for heating said one or more primary electrodes.

17. The method of claim 14 wherein applying energy from the energy source comprises applying UV radiation to said one or more primary electrodes.
